(19) United States
(12) Patent Application Publication
(10) Pub. No.: US 2022/0062807 A1
(43) Pub. Date: Mar. 3, 2022

(54) ANTIVIRAL GLASS FIBER TREATMENT, PROCESS AND METHOD OF MANUFACTURING

(71) Applicant: UOP LLC, Des Plaines, IL (US)

(72) Inventors: James M. Hodges, Evanston, IL (US); F. Stephen Lupton, Evanston, IL (US); Robert L. Bedard, McHenry, IL (US); Erin M. Broderick, Arlington Heights, IL (US); Dennis F. van der Vliet, Skokie, IL (US); Mana Moarrefzadeh, Wheeling, IL (US)

(21) Appl. No.: 17/412,557

(22) Filed: Aug. 26, 2021

Related U.S. Application Data
(60) Provisional application No. 63/071,877, filed on Aug. 28, 2020.

(51) Int. Cl. B01D 39/20; A01N 57/34; A01N 55/00; D21H 17/13; D21F 11/14; D21H 27/08; D21H 13/40; B01D 39/16

(52) U.S. Cl. CPC B01D 39/2017; A01N 57/34; A01N 55/00; D21H 17/13; B01D 2239/0442; D21H 27/08; D21H 13/40; B01D 39/1615; B01D 2239/0216; D21F 11/14

(57) ABSTRACT

Processes for increasing the viricidal activity of a fiber substrate. The fiber substrate is provided. An antiviral treatment containing a quaternary ammonium or phosphonium compound is introduced to the fiber substrate to form an antiviral substrate. The treated fiber substrate is washed and dried. The antiviral treatment may occur before or after the fiber substrate is incorporated into the HEPA filter media in a papermaking process. Also a filter made from treated fiber substrates.

### RELATED APPLICATIONS

This application claims priority to U.S. Provisional Application having Ser. No. 63/071,877 filed on Aug. 28, 2020, the entirety of which is incorporated herein by reference.

### FIELD OF THE INVENTION

This invention relates generally to the treatment of glass fibers, preferably glass fibers used in filter media, where the treatment imparts the fiberglass substrate with increased viricidal activity relative to the untreated fiberglass, and the method for applying such treatments.

### BACKGROUND OF THE INVENTION

The emergence of the coronavirus known as “Covid-19” has created a global pandemic resulting in an enormous number of infected individuals requiring hospitalization, and in many cases, resulting in the death of the infected individual. the unforeseen pandemic has highlighted the resulting need for physical or chemical agent that are capable of deactivating or destroying viruses like the Covid-19 virus.

Coronaviruses are a group of viruses that usually cause mild illnesses, such as the common cold. However, certain types of coronavirus can infect the lower airway, causing serious illnesses like pneumonia or bronchitis. Most people get infected with coronaviruses at some point in their lives and the majority of these infections are harmless. The new coronavirus that causes the covid-19 illness is a notable exception.

Coronaviruses have extraordinarily large single-stranded RNA genomes—approximately 26,000 to 32,000 bases or RNA “letters” in length. Coronavirus particles are surrounded by a fatty outer layer called an envelope and usually appear spherical, as seen under an electron microscope, with a crown or “corona” of club-shaped spikes on their surface.

Accordingly, the unforeseen pandemic has highlighted the need for physical or chemical agents that are capable of deactivating or destroying viruses like the COVID-19 virus.

High-Efficiency Particulate Air (HEPA) filtration and Ultra-Low Particulate Air (ULPA) filtration may be used to remove particles from the air. The ULPA standard requires removal of 99.9995% of particles down to 1.2 micrometers. Both HEPA and ULPA filters consist of innumerable tiny strands of randomly arranged glass microfibers, typically alkali borosilicate glass compositions for HEPA and low boron compositions for ULPA in cleanroom applications.

Fiberglass wet-laid media is found in high-pressure hydraulic filtration, because the glass fibers are non-compressible and provide excellent dirt-holding capacity. Fiberglass fiber can be made quite fine, even sub-micron in diameter, and is the material of choice for HEPA filters for clean rooms, coalescing media, airliner and other ECS (environmental control systems), hospital and other health care air filtration, and certain laboratory filters.

Although existing glass HEPA filter media is known to effectively remove infectious agents such as viruses from air, most existing filter media have not been rendered viricidal. Quaternary ammonium compounds, as well as quaternary phosphonium compounds, have antiviral properties but are difficult to incorporate into glass or cellulose substrates without adversely affecting the performance of the substrate as a material used in filter media.

In most current processes, quaternary ammonium compounds are incorporated into fiberglass filter media by spraying the compounds onto laid fibers at the final stage of the papermaking process. However, while presumably effective for their intended purposes, a drawback to these methods is that the viricidal compounds are confined to the outside surfaces of the as-formed filter and are not able to fully access the interior of the filter. Preferably, an antiviral treatment would deliver a homogeneous distribution of viricidal agents throughout the entire filter media, which would significantly increase the probability that viruses and virus-containing aerosols come in contact with viricidal compounds.

Accordingly, there remains a need for more effective and efficient processes for treating fiber-based substrates, such as fiberglass and cellulose, to produce filter media with well-dispersed antiviral compounds, and in particular a need that such processes may be more easily integrated into existing papermaking processes.

### SUMMARY OF THE INVENTION

The present invention provides new methods for treating fiber substrates, such as fiberglass filter media, with a viricidal treatment having, for example, quaternary ammonium. The antiviral treatment can be accomplished in the wet end of a filter media paper machine in a mixing tank prior to the headbox, in the headbox shortly before wet laying on a moving forming fabric, or subsequent to wet-laying before, during, or after the addition of binder resins to the formed media and prior to drying. This ensures that the viricidal quaternary ammonium agents are well distributed throughout the filter media, delivering a version of the filter media with the highest viricidal activity. Importantly, the present processes may be integrated into existing filter and papermaking technologies. The process can accommodate a wide variety of quaternary ammonium and quaternary phosphonium compounds, where the antiviral compound that is most compatible with the fiber substrate can be selected for the treatment.

This invention provides a new approach for incorporating quaternary ammonium compounds and quaternary phosphonium compounds onto various substrates, especially fiberglass and cellulose, using anti-viral treatments that can be integrated into existing filter technologies. Moving forward, anti-viral filters are predicted to play an important role in ensuring the safety of employees, customers, and students as they return to indoor environments. Importantly, the technology or process resulting from this invention is amenable with existing fiber and papermaking technologies, and a wide variety of quaternary ammonium and quaternary phosphonium compounds can be used in the process.

An aspect of the invention is the use of quaternary ammonium or phosphonium compounds that contain a silane group with at least one, and as many as three hydrolysable groups, which facilitate attachment to the fiber substrate through a silanization process. Possible hydrolysable groups include, but are not limited to, alkoxy groups, acyloxy groups, halides, and amines. Additionally, the length of the linker and location of the quaternary ammonium group within the molecule may be selected based on the chemistry of the fiber surface and the targeted functionality of the filter media.

Another aspect of the invention is a method for stabilizing the silane group on the quaternary ammonium compound that facilitates attachment of the antiviral moiety onto the fiber substrate. This may be accomplished by reacting the organosilane with a chelating agent, including, but not limited to, a polyol containing up to three hydroxy groups, which prevents the organosilane from undergoing premature hydrolysis and subsequent homocondensation when in an aqueous solution. This process allows these compounds to be stored in water for extended periods of time, and eliminates the need for flammable solvents that can be problematic in manufacturing.

Therefore, the present invention may be characterized, in at least one aspect, as providing a process for forming a filter by: providing a plurality of fibers; introducing the fibers to an antiviral compound, wherein the antiviral compound is a quaternary ammonium compound or a quaternary phosphonium compound; attaching the antiviral compound to the fibers through a silanization process to provide treated fibers; and, forming a filter with the treater fibers.

In another aspect, the present invention may be generally characterized as providing a filter having a plurality of fibers. The fibers each have an antiviral compound attached to the fiber by a silane linkage. The antiviral compound is a quaternary ammonium or a quaternary phosphonium. There is a distribution of the antiviral compound is uniform throughout the filter.

Additional aspects, embodiments, and details of the invention, all of which may be combinable in any manner, are set forth in the following detailed description of the invention.

### DETAILED DESCRIPTION OF THE DRAWINGS

With these general principles in mind, one or more embodiments of the present invention will be described below in conjunction with the following drawing figures, in which:

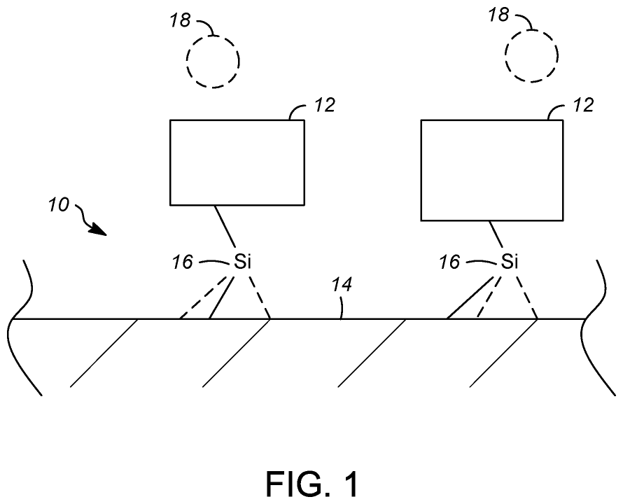

FIG. 1 shows a schematic view of a surface of a fiber that has been treated according to the present invention;

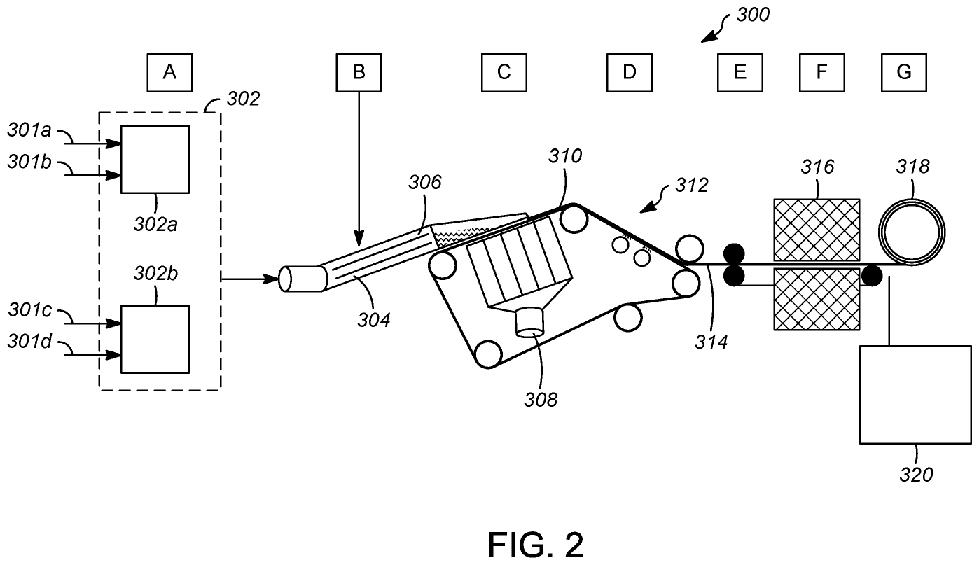

FIG. 2 shows a papermaking process according to an embodiment of the present invention; and,

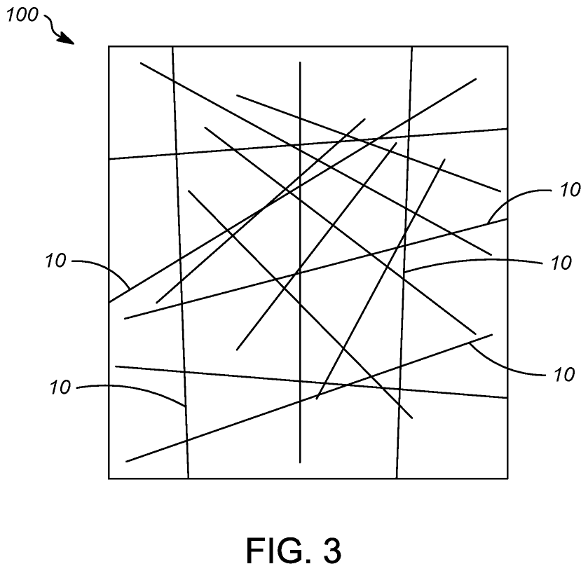

FIG. 3 shows a top view of a filter formed from fibers according to the present invention.

### DETAILED DESCRIPTION OF THE INVENTION

As mentioned above, the processes disclosed in the invention creates an antiviral surface on a fiber substrate, such as fiberglass or cellulose. The antiviral surface is created by treating the fibers with a quaternary ammonium or phosphonium compound, where the resulting fibers have increased viricidal activity compared to the untreated fiber substrate. According to the present invention, the quaternary ammonium and phosphonium compounds include a silane group with one to three hydrolysable groups, such as alkoxy groups or halides, which facilitate attachment to the surface of the fibers through a silanization process. The treatment may be preferably carried out on hydrophilic substrates (filters, cloths, wet-laid media, other surfaces of interest), although hydrophobic surfaces may also be treated by using suitable modification known in the art. Compared to the untreated fiber substrate, the treated fibers have increased viricidal properties.

As discussed herein, the use of antiviral or viricidal properties is also believed to provide antibacterial properties as well. Since the enumeration of viruses requires specialized skills and equipment as well exceptionally clean environments to conduct this analysis, bacterial surrogates are often used determine general biocidal efficacy of anti-microbial treatments. This is especially true with the use of vegetative gram-negative bacteria and enveloped viruses which both possess a lipid bilayer cell envelope that is a target for many biocidal agents such as metals and quaternary ammonium compounds. An example of this is Schmidt, Marcel, “Identification of potential bacterial surrogates for validation of thermal inactivation processes of hepatitis A virus.” Master's Thesis, University of Tennessee, 2016. It is generally known that these bacterial surrogates are more resistant to biocides than their viral counterparts so that when efficacy of anti-microbial agents are demonstrated against these surrogates, similar or better anti-microbial activity against corresponding enveloped viruses. For example, disinfectants that show viricidal activity against human coronavirus within 30 seconds require 1 minute of contact time to demonstrate efficacy against a vegetative gram negative bacterium such as Serratia. Therefore, the use of bacterial surrogates is a valid approach to ensure biocidal agents are similarly effective against corresponding enveloped viruses.

With these general principles in mind, one or more embodiments of the present invention will be described with the understanding that the following description is not intended to be limiting.

As shown in FIG. 1, a fiber 10 treated according to the present invention has a treatment that bonds an antiviral compound 12 that is either a quaternary ammonium or a phosphonium compound with an outer surface 14 of the fiber 10. According to the present invention, the antiviral compound 12 is bonded via at least one silane linkage 16 to the fiber 10. Additionally, the fiber 10 may be further treated by incorporating metal nanoparticles 18 onto the fibers 10.

The fibers may be any type of fiber typically used in filter media such a glass fibers or cellulose fibers. For example, the fibers may be A-glass fiber, B-glass fiber, C-glass fiber, D-glass fiber, E-glass fiber, ECR glass fiber, T-glass fiber, M-glass fiber, and mixtures thereof. In an embodiment, the fibers are a biosoluble glass fibers such as a low Al₂O₃ glass fiber with high B₂O₃, and either a high Na₂O+K₂O content or high CaO+MgO content.

The fibers have a surface area of between at least 1 and 10 m²/g, or between 2 and 10 m²/g, or between 3 and 8 m²/g. Unless specified otherwise, ranges described herein broadly include the end points of the specified ranges.

The fibers 10, shown in FIG. 1, may be provided in a dry form, in suspension, or otherwise dispersed in a liquid medium. Additionally, the fibers 10 may be provided loosely or as a formed substrate. It is thought that the present processes are easily incorporated into the production process of a filter or other article that includes the fiber substrate 10. For example, the present treatment processes may be advantageously accomplished in the wet-end of a filter media paper machine in a mixing tank prior to the headbox, in the headbox shortly before wet-laying on a moving forming fabric, or subsequent to wet-laying before, during, or after the addition of binder resins to the formed media and prior to drying. Such production processes like wet-laying and dry-laying are well known in the art.

The quaternary ammonium/phosphonium compounds that may be used as the antiviral compound 12 are preferably represent by the following Chemical Formula 1:

X₃—Si—(CH₂)ₙ—QR₃ [Chemical Formula 1].

In Chemical Formula 1, Q represents a nitrogen or phosphorous atom, R represents, independently, a C1 to C25 alkene, alkyl, aryl, or an alkyne group. Further, X represents, independently, hydrolysable groups which may be a C1 to C10 alkoxy group, a halide, an amine, or an acyloxy groups. Finally, n in Chemical Formula 1 may be between 1 to 25. For example, one particular compound that may be used as the quaternary ammonium and/or phosphonium compound 12, shown in FIG. 1, is dimethyloctadecyl[3-(trimethoxysilyl)propyl]ammonium chloride (DTSACI).

The fiber 10 preferably has between 1 to 10,000 ppm of a total nitrogen or phosphorus after the antiviral compound 12 has bonded to the fibers 10. As discussed above, according to the present invention, the bonds formed between antiviral compound 12 and the fiber 10 are the result of at least one, and up to three silane linkages.

The antiviral compound 12 may be applied by any known process including providing a solution with the antiviral compound 12 and dipping in, spraying on, or brushing on the solution to the fibers 10. The solution may have between 0.0001 wt % and 20 wt % quaternary ammonium/phosphonium compounds in a solvent or mixture of solvents, including, but not limited to, water, methanol, and ethanol. The solution may include a chelating agent to stabilize the silane groups on the antiviral compound, which includes, but is not limited to, a polyol containing up to three hydroxy groups, which coordinates with the silane group, mitigates undesirable homocondensation reactions between hydrolyzed silanes.

Alternatively, the ammonium/phosphonium compounds may be incorporated into a wet-laying or dry-laying production process. For example, the ammonium/phosphonium compounds maybe introduced to the fibers at various points during a paper-making process. For example, the ammonium/phosphonium compounds can be introduced to the fibers 10 in one or more of the following unit operations of a paper-making process: a wet-end mix tank, a machine chest, a headbox or binder impregnation section of a paper machine selected from a group consisting of: fourdrinier, twin-wire machine, Rotoformer®, and Delta Former® or other inclined-type paper machines.

It should be appreciated that any suitable method for creating a glass fiber slurry may be used. In some cases, ammonium/phosphonium compounds and any additional additives are added to the slurry to facilitate processing. The temperature and pH may also be adjusted to a suitable range. In some embodiments, the temperature and pH of the slurry are maintained. In some cases, the temperature and pH are not actively adjusted.

In some embodiments, the wet laid process uses similar equipment as a conventional papermaking process, which includes a hydropulper, a former or a headbox, a dryer, and an optional converter. For example, the slurry may be prepared in one or more pulpers. After appropriately mixing the slurry in a pulper, the slurry may be pumped into a headbox, where the slurry may or may not be combined with other slurries or additives may or may not be added. The slurry may also be diluted with additional water such that the final concentration of fiber is in a suitable range.

In some embodiments, the process then involves introducing binder into the pre-formed fiber web. In some embodiments, as the fiber web is passed along an appropriate screen or wire, different components included in the binder (e.g., soft binder, optional hard binder), which may be in the form of separate emulsions, are added to the fiber web using a suitable technique. The antiviral compound 12 may also be appropriately added to the fiber web along with the binder or independently from the binder. In some cases, each component of the binder resin is mixed as an emulsion prior to being combined with the other components and/or fiber web. The antiviral compound 12 may also be provided as an emulsion prior to mixing with the binder and incorporation into the fiber web. In some embodiments, the components included in the binder along with the antiviral compound 12 may be pulled through the fiber web using, for example, gravity and/or vacuum. In some embodiments, one or more of the components included in the binder resin and/or the antiviral compound 12 may be diluted with softened water and pumped into the fiber web.

In some embodiments, the antiviral compound 12 may be added after the binder and other components have been added. For example, the antiviral compound 12 may be introduced into the fiber web in a downstream step after the binder components have already been introduced into the web. In another example, the antiviral compound 12 may be introduced into the fiber web along with the binder, or wherein the one or more antiviral compounds 12 are added last in the process (e.g., before or after the drying of the fiber web).

After the binder and the antiviral compound 12 are incorporated into the glass fiber web, the wet-laid fiber web may be appropriately dried. In some embodiments, the wet-laid fiber web may be drained. In some embodiments, the wet-laid fiber web may be passed over a series of drum dryers to dry at an appropriate temperature (e.g., about 50° C. to 150° C., or any other temperature suitable for drying). For some cases, typical drying times may vary until the moisture content of the composite fiber is as desired. In some embodiments, drying of the wet-laid fiber web may be performed using infrared heaters. In some cases, drying will aid in curing the fiber web. In addition, the dried fiber web may be appropriately reeled up for downstream filter media processing.

As an example, a filter media may be prepared by a wet laid process where a first dispersion (e.g., a pulp) containing a glass fiber slurry (e.g., glass fibers in an aqueous solvent such as water) is applied onto a wire conveyor in a papermaking machine (e.g., fourdrinier or rotoformer), forming a first phase. A second dispersion (e.g., another pulp) containing another glass fiber slurry (e.g., glass fibers in an aqueous solvent such as water) is then applied onto the first phase. Vacuum is continuously applied to the first and second dispersions of fibers during the above process to remove solvent from the fibers, resulting in a filter media having a first phase and a second phase. The filter media formed is then dried. It can be appreciated that filter media may be suitably tailored not only based on the components of each glass fiber web, but also according to the effect of using multiple glass fiber webs of varying characteristics in appropriate combination. In a contemplated embodiment, one or more of the glass webs contains glass fibers having the antiviral compound 12.

For example, with reference to FIG. 2, a wet-laid process 300 includes a pre-headbox region A, a headbox region B, wet-laying region C, a binder region D, rolling region E, drying region F, and a post-drying region G. The pre-headbox region A comprises a first pre-mix tank 302a and a second premix tank 302b. In certain contemplated embodiments, the antiviral component can be introduced to the fibers in the pre-headbox region A, in the headbox region B, in the wet-laying region C, in the binder region D, in the rolling region E, and in the post-drying region G.

In the illustrated embodiment, in the pre-headbox region A, a first fiber 301a is provided and a first antiviral component 301b is introduced to the first fiber 301a. In a second pre-mix tank 302b, a second fiber substrate 301c and a second antiviral component 301d may be introduced.

The pre-headbox mixing 302 creates a fiber slurry 304. The fiber slurry is sent to the headbox 306, which is used to apply the fiber slurry to a wet-laid papermaking machine in wet-laying region C. The wet-laid papermaking machine comprises a suction box 308 to draw liquid out downward and inclined wire 310. Thereafter, binder 312 is applied to the wet-laid fiber. A nip roll press 314 compresses the web, and a dryer 316 removes excess moisture. Subsequently, a roller 318 is used to store the filter. Post-drying treatment 320 may include further coating or antiviral treatment.

After formation, the filter media may be further processed according to a variety of known techniques. For example, the filter media may be pleated and used in a pleated filter element. In some embodiments, filter media, or various layers thereof, may be suitably pleated by forming score lines at appropriately spaced distances apart from one another, allowing the filter media to be folded. It should be appreciated that any suitable pleating technique may be used.

It should be appreciated that the filter media may include other parts in addition to the fiber web. In some embodiments, the filter media may include more than one fiber web. In some embodiments, further processing includes incorporation of one or more structural features and/or stiffening elements. The fiber web(s) may be combined with additional structural features such as polymeric and/or metallic meshes. For example, a screen backing may be disposed on the filter media, providing for further stiffness. In some cases, a screen backing may aid in retaining the pleated configuration. For example, a screen backing may be an expanded metal wire or an extruded plastic mesh.

The filter media may be incorporated into a variety of suitable filter elements for use in various applications including ASHRAE filter media applications. The filter media may generally be used for any air filtration application. For example, the filter media may be used in heating and air conditioning ducts. The filter media may also be used in combination with other filters as a pre-filter, such as for example, acting as a pre-filter for high efficiency filter applications (e.g., HEPA). Filter elements may have any suitable configuration as known in the art including bag filters and panel filters.

Theories on filtration generally propose multiple particle capture mechanisms that include direct impact of higher momentum particles, attraction by natural forces of smaller, lower momentum particles to fiber surfaces, diffusional, or probabilistic contact of submicron particles with media fibers, and electrostatic forces, with the dominant mechanism being a function of the captured particle size and its electrostatic or surface charge. There is a particle size range that is too small for appreciable momentum effects yet too large for major contributions from diffusion effects. This size range is referred to as the most penetrating particle size (MPPS), which for HEPA media is usually in the 0.3 micron range.

A real world particle size distribution, for instance from aerosols created by exhaled air, coupled with additional variation of liquid or mucus content of the breathed particles, results in the captured bacteria and viruses-containing particles penetrating HEPA media to different depths as a function of the capture efficiency as described above. Prior art treatments are usually created by spraying the already manufactured HEPA media with coatings of antibacterial and antiviral species. These treatments are concentrated on one or both of the outside surfaces of the media, therefore not effectively interacting with particles that have penetrated into the media beyond the sprayed-on coating. Even antimicrobial coating of premanufactured media by dipping would not be expected to uniformly treat the entire depth of the media since interaction with the first encountered fibers would likely deposit higher quantities of antimicrobial species, thereby similarly creating a non-uniform distribution. Accordingly, in certain embodiments of the present invention, application of the antiviral compound to the fibers of the filter before the filter is made results in relatively uniform distribution of antibacterial and antiviral species through the thickness of the HEPA media. This maximizes the antibacterial and antiviral effectiveness of the media throughout the entire range of possible microbe-containing particle size and properties.

In order to bond the quaternary ammonium and phosphonium compound 12, excess solution may be removed and the fibers 10 may be subjected to a mild heat treatment. For example, the heat treatment may include heating the fibers at a temperature between 50 and 150° C. for a time between 1 minute to one hour. Prior to heat treatment, the fibers may be dried at a temperature between 80 to 120 C for a time between 1 minute to 1 hour. After the heat treatment, the fibers 10 may be washed to remove excess quaternary ammonium and phosphonium compound 12 and then the fibers may be dried at a temperature between 80 to 120 C for a time between 1 minute to 5 hours.

After hydrolysis and attachment of the antiviral compound 12 to the fiber substrate, the fibers preferably have between 1 to 10,000 ppm of a total nitrogen or phosphorus. After attaching the antiviral compound 12 to the fiber, the number of silanes tethered to the outer surface of the fiber substrate 10 is at least 10¹⁵ per m² and at most 2×10¹⁸ per m². As discussed above, according to the present invention, the antiviral compound 12 is bonded as a result of silane linkages 16 between the antiviral compound 12 and the fiber.

As shown in FIG. 3, the treated fibers 10 may be used to form a fiber-based substrate, like the filter 100. Again, the treatment may occur during the production of the filter 100, or the filter 100 may be produced and then subjected to a treatment according to the present invention. In either case, the present treatment increases the antiviral/antibacterial antiviral properties of the treated fibers 10, without adversely affecting the performance of the fibers as a material used in filter media.

Returning to FIG. 1, it is further contemplated that metal nanoparticles 18 are added to the fibers 10. The metal nanoparticles may include silver, copper, zinc, titanium, gold, iron, and mixtures thereof. The metal in the nanoparticle may be elemental metal (zero oxidation state), or in some cases may be an oxide or ionic. The use of the name of the metal is intended to include any and all of the various forms (i.e., oxides, ions, elemental) that have antiviral/antibacterial antiviral properties. The metal nanoparticle may have a diameter between 1 to 200 nm. The diameter may be measured and determined by scanning transmission electron microscopy or transmission electron microscopy. The metal nanoparticles may also be provided in a liquid form such as a solution or a suspension. The metal nanoparticles may be provided in liquid form at a concentration between 0.02 mg/mL to 5 mg/mL. The liquid form in some embodiments may be the solution which includes the antiviral compound 12.

### EXPERIMENTAL EXAMPLES

### Example 1: High Loading

A solution was prepared by adding 12 mL of a 42 weight % solution of dimethyloctadecyl[3-(trimethoxysilyl)propyl]ammonium chloride (DTSACI) in methanol to a solution of 90 mL methanol and 10 mL deionized water under a nitrogen atmosphere. The DTSACI was allowed to hydrolyze overnight (˜12 hours). A 4 L beakers equipped with overhead stirrers was setup, and a solution of 1350 mL methanol and 150 mL deionized water was added to the beaker. To the beaker, 90 mL of the DTSACI solution was added while stirring at 400 RPM using an overhead stirrer. 10 mL of the DTSACI solution was added to the second beaker (Example 2).

15 g of glass microfibers (C-04-F glass microfibers from Unifrax) was added to the solution and allowed to react for 2.5 hours. The sample was then vacuum-filtered, then washed with 1 L of deionized water, then 500 mL of methanol, and then 500 mL of deionized water. The resulting product was dried under vacuum overnight, and then for 3 hours in a drying oven at 75° C. to form a non-woven filter cake.

Two pieces of the filter cake were submitted for ICP elemental analysis, one from the center of the cake and one from the edge. The analysis showed that the piece from the center of the cake had 0.55 wt % C, while the edge of the cake had 0.44 wt % C, indicating homogeneity of the DTSACl compound throughout the filter cake. The analysis showed that for Example 2 (low loading), the piece from the center of the cake had 0.37 weight % C, while the edge of the cake had 0.35 weight % C, indicating good homogeneity of the DTSACl compound throughout the substrate.

### Example 2: Low Loading

A solution was prepared by adding 12 mL of a 42 weight % solution of dimethyloctadecyl[3-(trimethoxysilyl)propyl]ammonium chloride (DTSACI) in methanol to a solution of 90 mL methanol and 10 mL deionized water under a nitrogen atmosphere. The DTSACI was allowed to hydrolyze overnight (˜12 hours). A 4 L beakers equipped with overhead stirrers was setup, and a solution of 1350 mL methanol and 150 mL deionized water was added to the beaker. To the beaker, 10 mL of the DTSACI solution was added while stirring at 400 RPM using an overhead stirrer.

Approximately 15 g of glass microfibers (C-04-F glass microfibers from Unifrax) was added to the solution and allowed to react for 2.5 hours. The sample was then vacuum-filtered, then washed with 1 L of deionized water, then 500 mL of methanol, and then 500 mL of deionized water. The resulting product was dried under vacuum overnight, and then for 3 hours in a drying oven at 75° C. to form a non-woven filter cake.

Two pieces of the filter cake were submitted for ICP elemental analysis, one from the center of the cake and one from the edge. The analysis showed that the piece from the center of the cake had 0.37 weight % C, while the edge of the cake had 0.35 weight % C, also indicating good homogeneity of the DTSACl compound throughout the substrate.

### Specific Embodiments

While the following is described in conjunction with specific embodiments, it will be understood that this description is intended to illustrate and not limit the scope of the preceding description and the appended claims.

A first embodiment of the invention is a process for forming a filter, the process comprising providing a plurality of fibers; introducing the fibers to an antiviral compound, wherein the antiviral compound is a quaternary ammonium compound or a quaternary phosphonium compound; attaching the antiviral compound to the fibers through a silanization process to provide treated fibers; and, forming a filter with the treater fibers. An embodiment of the invention is one, any or all of prior embodiments in this paragraph up through the first embodiment in this paragraph, wherein the fibers are selected from a group consisting of cellulose, A-glass fiber, C-glass fiber, D-glass fiber, E-glass fiber, ECR glass fiber, T-glass fiber, Z-glass fiber, M-glass fiber, a biosoluble fiber, and mixtures thereof. An embodiment of the invention is one, any or all of prior embodiments in this paragraph up through the first embodiment in this paragraph, wherein the antiviral compound is introduced to the fibers at a wet end of a HEPA media paper machine in a mixing tank prior to a headbox, in a headbox shortly before wet laying on a moving forming fabric, or subsequent to wet-laying before, during, or after addition of binder resins to a formed filter and prior to drying. An embodiment of the invention is one, any or all of prior embodiments in this paragraph up through the first embodiment in this paragraph, wherein the antiviral compound is represented by the following Chemical Formula 1 X₃—Si—(CH₂)ₙ—QR₃ [Chemical Formula 1], wherein Q in Chemical Formula 1 represents nitrogen or phosphorous, wherein R represents, independently, a C1 to C25 alkene, alkyl, aryl, or alkyne group, wherein X, independently, represents, a C1 to C10 alkoxy group, a halide, an amine, or an acyloxy groups, and, wherein n is between 1 to 25. An embodiment of the invention is one, any or all of prior embodiments in this paragraph up through the first embodiment in this paragraph, wherein the treated fibers each comprise between 1 to 10,000 ppm of nitrogen and phosphorus. An embodiment of the invention is one, any or all of prior embodiments in this paragraph up through the first embodiment in this paragraph, wherein the treated fibers have at least 10¹⁵ silanes per m² of fiber surface. An embodiment of the invention is one, any or all of prior embodiments in this paragraph up through the first embodiment in this paragraph, wherein the fibers each comprise a surface area of between at least 1 and 10 m²/g. An embodiment of the invention is one, any or all of prior embodiments in this paragraph up through the first embodiment in this paragraph, wherein an antiviral solution comprising the antiviral compound is applied on the fibers in one or more of the following unit operations of a paper-making process a wet-end mix tank, a machine chest, a headbox or binder impregnation section of a paper machine selected from a group consisting of fourdrinier, twin-wire machine, Rotoformer®, and Delta Former® or other inclined-type paper machines. An embodiment of the invention is one, any or all of prior embodiments in this paragraph up through the first embodiment in this paragraph, wherein a solution with the antiviral compound is introduced to the fibers at a beginning of a paper making process. An embodiment of the invention is one, any or all of prior embodiments in this paragraph up through the first embodiment in this paragraph, wherein the solution with the antiviral compound is added to a paper machine headbox at an effective time of 0 to 60 minutes prior to a wet-laying of the fibers. An embodiment of the invention is one, any or all of prior embodiments in this paragraph up through the first embodiment in this paragraph, wherein a silane group on the antiviral compound is treated with a chelating agent. An embodiment of the invention is one, any or all of prior embodiments in this paragraph up through the first embodiment in this paragraph wherein the chelating agent comprises a polyol containing up to three hydroxy groups. An embodiment of the invention is one, any or all of prior embodiments in this paragraph up through the first embodiment in this paragraph, wherein the filter is formed by a wet-laying process. An embodiment of the invention is one, any or all of prior embodiments in this paragraph up through the first embodiment in this paragraph, wherein the filter is formed by a dry laying process.

A second embodiment of the invention is a fiber comprising a plurality of fibers, wherein the fibers each comprise an antiviral compound attached to the fiber by a silane linkage, wherein the antiviral compound is a quaternary ammonium or a quaternary phosphonium, and, wherein a distribution of the antiviral compound is uniform throughout the filter. An embodiment of the invention is one, any or all of prior embodiments in this paragraph up through the second embodiment in this paragraph, wherein the fibers are selected from a group consisting of cellulose A-glass fiber, C-glass fiber, D-glass fiber, E-glass fiber, ECR glass fiber, AR-glass fiber, R-glass fiber, S-glass fiber, T-glass fiber, S2-glass fiber, Z-glass fiber, M-glass fiber, a biosoluble fiber, and mixtures thereof. An embodiment of the invention is one, any or all of prior embodiments in this paragraph up through the second embodiment in this paragraph, wherein the antiviral compound is represented by the following Chemical Formula 1 X₃—Si—(CH₂)ₙ—QR₃ [Chemical Formula 1], wherein Q in Chemical Formula 1 represents nitrogen or phosphorous, wherein R represents, independently, a C1 to C25 alkene, alkyl, aryl, or an alkyne group, wherein X, independently, represents, a C1 to C10 alkoxy group, a halide, an amine, or an acyloxy groups, and, wherein n is between 1 to 25. An embodiment of the invention is one, any or all of prior embodiments in this paragraph up through the second embodiment in this paragraph, wherein the fibers each comprise between 1 to 10,000 wppm of nitrogen and phosphorus. An embodiment of the invention is one, any or all of prior embodiments in this paragraph up through the second embodiment in this paragraph, wherein a number of silanes bonds on the outer surface of the fiber is between at least 10¹⁵ per m² and 2×10¹⁸ per m². An embodiment of the invention is one, any or all of prior embodiments in this paragraph up through the second embodiment in this paragraph, wherein the fibers each comprise a surface area of between at least 1 and 10 m²/g. An embodiment of the invention is one, any or all of prior embodiments in this paragraph up through the second embodiment in this paragraph, wherein an antiviral solution comprising the antiviral compound is applied on the fibers in one or more of the following unit operations of a paper-making process a wet-end mix tank, a machine chest, a headbox or binder impregnation section of a paper machine selected from a group consisting of fourdrinier, twin-wire machine, Rotoformer®, and Delta Former® or other inclined-type paper machines.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for forming a filter, the process comprising:
providing a plurality of fibers;
introducing the fibers to an antiviral compound, wherein the antiviral compound is a quaternary ammonium compound or a quaternary phosphonium compound;
attaching the antiviral compound to the fibers through a silanization process to provide treated fibers; and,
forming a filter with the treater fibers.

2. The process of claim 1, wherein the fibers are selected from a group consisting of: cellulose, A-glass fiber, C-glass fiber, D-glass fiber, E-glass fiber, ECR glass fiber, T-glass fiber, Z-glass fiber, M-glass fiber, a biosoluble fiber, and mixtures thereof.

3. The process of claim 1, wherein the antiviral compound is introduced to the fibers at a wet end of a filter media paper machine in a mixing tank prior to a headbox, in a headbox shortly before wet laying on a moving forming fabric, or subsequent to wet-laying before, during, or after addition of binder resins to a formed filter and prior to drying.

4. The process of claim 1, wherein the antiviral compound is represented by the following Chemical Formula 1:
X₃—Si—(CH₂)ₙ—QR₃ [Chemical Formula 1],
wherein Q in Chemical Formula 1 represents nitrogen or phosphorous,
wherein R represents, independently, a C1 to C25 alkene, alkyl, aryl, or alkyne group,
wherein X, independently, represents, a C1 to C10 alkoxy group, a halide, an amine, or an acyloxy groups, and,
wherein n is between 1 to 25.

5. The process of claim 1, wherein the treated fibers each comprise between 1 to 10,000 ppm of nitrogen and phosphorus.

6. The process of claim 1, wherein the treated fibers have at least 10¹⁵ silanes per m² of fiber surface.

7. The process of claim 1, wherein the fibers each comprise a surface area of between at least 1 and 10 m²/g.

8. The process of claim 1, wherein an antiviral solution comprising the antiviral compound is applied on the fibers in one or more of the following unit operations of a paper-making process: a wet-end mix tank, a machine chest, a headbox or binder impregnation section of a paper machine selected from a group consisting of: fourdrinier, twin-wire machine, Rotoformer®, and Delta Former® or other inclined-type paper machines.

9. The process of claim 1, wherein a solution with the antiviral compound is introduced to the fibers at a beginning of a paper making process.

10. The process of claim 9, wherein the solution with the antiviral compound is added to a paper machine headbox at an effective time of 0 to 60 minutes prior to a wet-laying of the fibers.

11. The process of claim 1, wherein a silane group on the antiviral compound is treated with a chelating agent.

12. The process of claim 11 wherein the chelating agent comprises a polyol containing up to three hydroxy groups.

13. The process of claim 1, wherein the filter is formed by a wet-laying process.

14. The process of claim 1, wherein the filter is formed by a dry laying process.

15. A filter comprising:
a plurality of fibers, wherein the fibers each comprise an antiviral compound attached to the fiber by a silane linkage,
wherein the antiviral compound is a quaternary ammonium or a quaternary phosphonium, and,
wherein a distribution of the antiviral compound is uniform throughout the filter.

16. The filter of claim 15, wherein the fibers are selected from a group consisting of: cellulose A-glass fiber, C-glass fiber, D-glass fiber, E-glass fiber, ECR glass fiber, AR-glass fiber, R-glass fiber, S-glass fiber, T-glass fiber, S2-glass fiber, Z-glass fiber, M-glass fiber, a biosoluble fiber, and mixtures thereof.

17. The filter of claim 15, wherein the antiviral compound is represented by the following Chemical Formula 1:
X₃—Si—(CH₂)ₙ—QR₃ [Chemical Formula 1],
wherein Q in Chemical Formula 1 represents nitrogen or phosphorous,
wherein R represents, independently, a C1 to C25 alkene, alkyl, aryl, or an alkyne group,
wherein X, independently, represents, a C1 to C10 alkoxy group, a halide, an amine, or an acyloxy groups, and,
wherein n is between 1 to 25.

18. The filter of claim 15, wherein the fibers each comprise between 1 to 10,000 wppm of nitrogen and phosphorus.

19. The filter of claim 15, wherein a number of silanes bonds on the outer surface of the fiber is between at least 10¹⁵ per m² and 2×10¹⁸ per m².

20. The filter of claim 15, wherein the fibers each comprise a surface area of between at least 1 and 10 m²/g.
